(19) United States
(12) Patent Application Publication
(10) Pub. No.: US 2016/0232078 A1
(43) Pub. Date: Aug. 11, 2016

(54) SOFTWARE DEFINED NETWORK ECOSYSTEM

(71) Applicant: HEWLETT-PACKARD ENTERPRISE DEVELOPMENT LP, Houston, TX (US)

(72) Inventors: Debasish BISWAS, Palo Alto, CA (US); Swaminathan RANGANATHAN, Palo Alto, CA (US); Praveen MALA, Palo Alto, CA (US); Jacob H. RAPP, Palo Alto, CA (US)

(21) Appl. No.: 15/025,574

(22) PCT Filed: Apr. 29, 2014
(86) PCT No.: PCT/US2014/035896

§ 371 Date: Mar. 29, 2016

Related U.S. Application Data
(60) Provisional application No. 61/884,905, filed on Sep. 30, 2013.

(51) Int. Cl. G06F 11/36; H04L 29/08; G06F 9/445

(52) U.S. Cl. CPC G06F 11/3664; G06F 8/61; H04L 67/34

(57) ABSTRACT

A software defined network (SDN) ecosystem can include simulating operation of new SDN applications and providing access to SDN applications to users of the SDN ecosystem.

### CROSS-REFERENCE TO RELATED APPLICATIONS

This application claims priority to U.S. Provisional Application 61/884,905, filed Sep. 30, 2013, which is incorporated by reference.

### BACKGROUND

A software defined network (SDN) is a form of network virtualization in which the control plane (system that makes decisions that affect network traffic) is separated from the data plane (system that moves the network traffic) and implemented as software. The control plane refers to definition of how network traffic is handled (e.g., via protocols such as spanning tree, open shortest path first, border gateway protocol, etc.) in a network device. The data plane refers to the actual handling of the network traffic according to the control plane (e.g., using forwarding tables, routing tables, queues, etc.) in a network device. The control plane may be said to be distributed in a typical network where each network device includes a control plane and a data plane. Thus, in the event of network congestion, each network device may take corrective action largely independently of other network devices. However, in an SDN, network administrators can have programmable (e.g., centralized) control of network traffic without requiring physical access to the network's hardware devices. An ecosystem may refer to a system of interacting and/or interconnecting parts, such as in a business.

### BRIEF DESCRIPTION OF THE DRAWINGS

FIG. 1 is a diagram illustrating an example of a system according to the present disclosure.

FIG. 2 is a diagram illustrating an example of a device according to the present disclosure.

FIG. 3 is a diagram illustrating an example of a software defined network (SDN) ecosystem according to the present disclosure.

FIG. 4 is a flow chart illustrating a method according to the present disclosure.

### DETAILED DESCRIPTION

Software Defined Networking (SDN) is an emerging network architecture where network control is decoupled from forwarding and is directly programmable. This migration of control, formerly tightly bound in individual network devices, into accessible computing devices enables the underlying infrastructure to be abstracted for applications and network services, which can treat the network as a logical or virtual entity.

Existing SDN implementations may include a lack of a marketplace to sell and/or support SDN applications. As used herein, an SDN application refers to program instructions that can be installed on a network controller to provide and/or modify functionality to a new and/or existing SDN. Typically, the software that provides SDN functionality on an SDN controller is closed such that it cannot be altered by a user or party other than the developer of the software. Interested parties are not allowed to collaborate to customize or improve SDN functionality. Also, an ability for non-SDN-providers to develop SDN applications may be limited because the SDN provider may implement the SDN as a canned product (e.g., where the SDN provider provides and/or controls the software that manages the SDN). As such, some SDN implementations may be hindered by complexities such as legacy network human middleware (e.g., network administrators that are trained and knowledgeable about typical network structures and are not comfortable with SDNs).

In contrast, a number of examples of the present disclosure can provide an SDN ecosystem that facilitates programming SDNs to align with business goals. This SDN ecosystem can include a marketplace to facilitate sharing ideas and software developments. In accordance with examples of the present disclosure, an SDN ecosystem that integrates an SDN application store (e.g., SDN AppStore) with an SDN controller allows developers and application users to have quick and easy access to applications to be deployed onto the SDN controller.

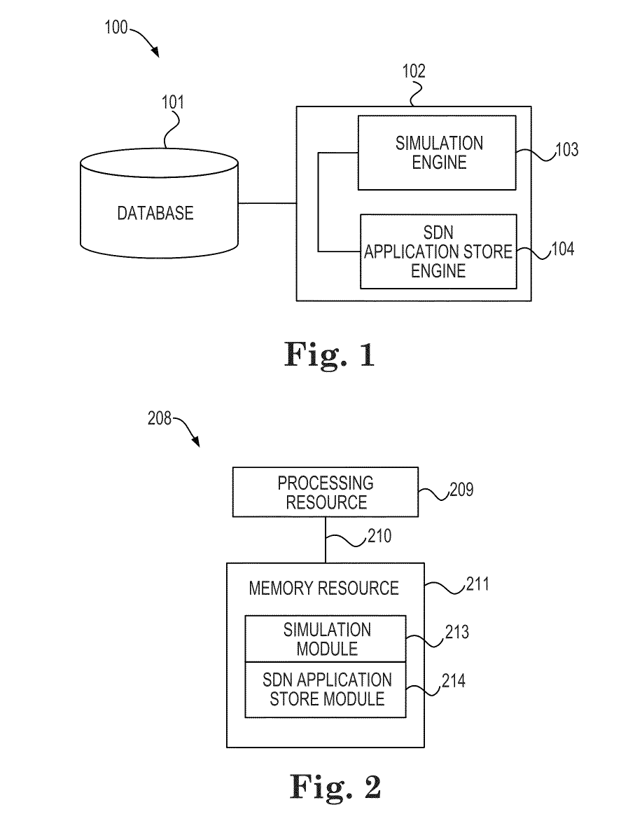

FIG. 1 is a diagram illustrating an example of a system 100 according to the present disclosure. The system 100 can include a database 101, a subsystem 102, and/or a number of engines 103, 104. As used herein, “a” or “a number of” something can refer to one or more such things. For example, “a number of widgets” can refer to one or more widgets. The subsystem can include the number of engines in communication with the database 101 via a communication link. The system 100 can include additional or fewer engines than illustrated to perform the various functions described herein. The system can represent software and/or hardware of a network controller (e.g., device 208 as referenced in FIG. 2, etc.).

The number of engines 103, 104 can include a combination of hardware and programming that is configured to perform a number of functions described herein (e.g., enable a user among a plurality of users to download a new software defined network (SDN) application into a development environment within an SDN ecosystem and simulate operation of the SDN application in a network environment, etc.). The programming can include program instructions (e.g., software, firmware, etc.) stored in a memory resource (e.g., computer readable medium (CRM), machine readable medium (MRM), etc.) as well as hard-wired program (e.g., logic).

The simulation engine 103 can include hardware and/or a combination of hardware and programming to enable a user among a plurality of users to download a new (e.g., not previously existing and/or available in an SDN application store available to the users) SDN application into a development environment within an SDN ecosystem and simulate operation of the new SDN application in a network environment. As discussed further herein, the SDN ecosystem can comprise a single architecture deployed across a data center network, a campus area network, and/or a plurality of branch networks. In some examples, the simulation engine 103 can provide a software development kit (SDK) to facilitate development, simulation, and validation of the new SDN application.

The SDN application store engine 104 can include hardware and/or a combination of hardware and programming to provide access to a plurality of SDN applications (e.g., including new SDN applications) to the plurality of users. In some examples, the SDN application store engine 104 can allow a first user of the plurality of users to develop a first SDN application to be added to the plurality of SDN applications in the SDN application store. Also, the SDN application store engine can allow a second user among the plurality of users to purchase a second SDN application among the plurality of SDN applications. For example, the second user can purchase the SDN application added to the plurality of SDN applications by the first user. In some examples, the SDN application store engine can allow a third user among the plurality of users to sell a third SDN application among the plurality of SDN applications. That is, users of the SDN ecosystem can develop, share, and/or purchase SDN applications provided by other users within the SDN ecosystem.

In some examples, the system 100 can include an interactive environment engine (not illustrated in FIG. 1) to enable collaboration between the plurality of users to modify the plurality of SDN applications, wherein the plurality of users include a customer, a developer, and a business partner of a provider of the SDN ecosystem.

Each of the number of engines 103, 104 can include hardware and/or a combination of hardware and programming that can function as a corresponding module as described with respect to FIG. 2. For example, the simulation engine 103 can include hardware and/or a combination of hardware and programming that can function as the simulation module 213. In another example, the SDN application store engine 104 can include hardware and/or a combination of hardware and programming that can function as the SDN application store module 214.

FIG. 2 is a diagram illustrating an example of a device 208 (e.g., a network controller) according to the present disclosure. The device 208 can utilize software, hardware, firmware, and/or logic to perform a number of functions.

The device 208 can be a combination of hardware and program instructions configured to perform a number of functions (e.g., actions). The hardware, for example, can include a number of processing resources 209 and a number of memory resources 211 (e.g., CRM, MRM, database, etc.). The memory resources 211 can be internal and/or external to the device 208 (e.g., the device 208 can include internal memory resources and have access to external memory resources). The program instructions (e.g., machine-readable instructions (MRI)) can include instructions stored on the MRM to implement a particular function (e.g., an action such as provide access to a plurality of SDN applications to the plurality of users). The MRI can be executable by one or more of the processing resources 209. The memory resources 211 can be coupled to the device 208 in a wired and/or wireless manner. For example, the memory resources 211 can be an internal memory, a portable memory, a portable disk, and/or a memory associated with another resource, e.g., enabling MRI to be transferred and/or executed across a network such as the Internet.

Memory resources 211 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 209 can be coupled to the memory resources 211 via a communication path 210. The communication path 210 can be local or remote to the device 208. Examples of a local communication path 210 can include an electronic bus internal to a machine, where the memory resources 211 are in communication with the processing resources 209 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 210 can be such that the memory resources 211 are remote from the processing resources 209, such as in a network connection between the memory resources 211 and the processing resources 209. That is, the communication path 210 can be a network connection. Examples of such a network connection can include LAN, wide area network (WAN), PAN, and the Internet, among others.

As shown in FIG. 2, the MRI stored in the memory resources 211 can be segmented into a number of modules 213, 214 that when executed by the processing resources 209 can perform a number of functions. As used herein, a module includes a set of instructions included to perform a particular task or action. The number of modules 213, 214 can be sub-modules of other modules. For example, the simulation module 213 can be a sub-module of the module SDN application store module 214 and/or the simulation module 213 and the SDN application store module 214 can be contained within a single module. Furthermore, the number of modules 213, 214 can comprise individual modules separate and distinct from one another. Examples are not limited to the specific modules 213, 214 illustrated in FIG. 2.

The simulation module 213 can simulate, in an SDN ecosystem, operation of a new SDN application, in response to receiving the new SDN application from a user of the SDN ecosystem. Further, the simulation module 213 can provide, to a provider of the SDN ecosystem, results from the simulated operation of the new SDN application.

The SDN application store module 214 can provide, to a plurality of users of the SDN ecosystem, access to the new SDN application in response to the provider of the SDN ecosystem approving the new SDN application. For instance, the SDN application store module 214 can execute instructions to provide the users of the SDN ecosystem with access to the plurality of SDN applications, including new SDN applications, using an SDN application store.

In some examples, as discussed further herein, the SDN application store module 214 can execute instructions to install a purchased SDN application on an SDN controller of a user among the plurality of users, in response to the user selecting the purchased SDN application from the application store. For instance, the SDN application store module 214 can use a virtual application networks (VAN) SDN controller in the SDN ecosystem to install the purchased SDN application on an SDN controller of the user.

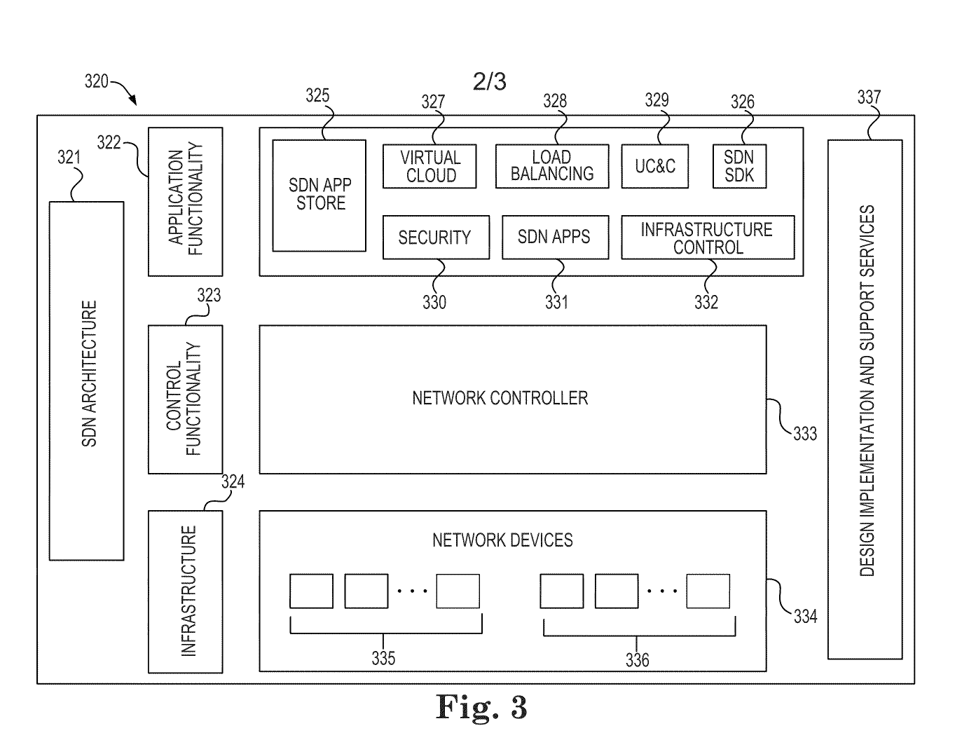

FIG. 3 is a diagram illustrating an example of a SDN ecosystem 320 according to the present disclosure. The SDN ecosystem 320 can include an SDN architecture 321. The SDN architecture 321 can include application functionality 322, control functionality 323, and/or infrastructure 324. Further, the application functionality 322 can include an SDN application store (e.g., SDN App Store) 325 and/or an SDN software development kit (SDK) 326. The application functionality can include a virtual cloud 327, load balancing 328, unified communications and collaboration (UC&C) 329, security 330, SDN applications 331, and/or infrastructure control 332. As illustrated in FIG. 3, the control functionality 323 can be provided by a network controller 333 (e.g., a virtual application networks (VAN) SDN controller). However, in some instances, an SDN application can be hosted by machines separate from the SDN controller. Also, as illustrated in FIG. 3, the infrastructure 324 can include a number of network devices 334 such as a number of switches 335 and/or a number of routers 336. In some examples, the SDN ecosystem 320 can provide design implementation and support services 337.

The SDN ecosystem 320 can include a network controller 333. An SDN is a form of network virtualization in which the control plane is separated from the data plane and implemented in a software application. Network administrators can therefore have programmable centralized control of network traffic without requiring physical access to the network's hardware devices. The network controller 333 can be hardware and/or software. A hardware network controller 333 include a processing resource in communication with a memory resource. The memory resource can include instructions, executable by the processing resource to perform a number of functions described herein. In some examples, the network controller 333 can be a discrete device, such as a server. In some examples, the network controller 333 can be a distributed network controller, for example, such as a cloud-provided functionality. Also, the network controller 333 can be in communication with and/or have control over a number of network devices.

In some examples, a software network controller 333 can be a VAN SDN controller. The VAN SDN controller 333 can be offered as licensable software to provide centralized automation for an SDN and/or open application programming interfaces (APIs) to enable third-party SDN application development. The VAN SDN controller 333 can have an extensible, scalable, and/or resilient controller architecture that can provide simplified management, provisioning, and/or orchestration in the SDN architecture 321. The VAN SDN controller 333 can help provide a federated network solution designed to provide unified automation of, and visibility into, physical and virtual data center networks, enabling business agility and improving business continuity.

An SDN ecosystem 320 can include a programmable network aligned to business applications. That is, the SDN ecosystem 320 can conform to a number of open standards to facilitate efficient use for different customers, partners, businesses, etc. In some examples, the SDN ecosystem 320 can be deployed across a data center network, a campus area network, and/or a branch network. Any combination of the data center network (or multiple data center networks), the campus area network (or multiple campus area networks), and the branch network (or multiple branch networks) can be included in the SDN ecosystem 320.

An SDN application (e.g., SDN App) 331 can be program instructions (e.g., a Java program) that can be executed on the network controller 333 (e.g., as an Open Services Gateway initiative (OSGi) bundle using a Java SDK) or off the network controller 333 using an API implemented by the network controller 333 (e.g., a northbound interface that conceptualizes the lower level details such as data or functions). As used herein, OSGi refers to a specification for Java based frameworks for development and dynamic deployment of modular components and libraries of a system. Some OSGi implementations can include Equinox, Apache Felix, and/or Knopflerfish OSGi. On OSGi bundle can be a tightly coupled, dynamically loadable collection of classes, jars, and/or configuration files onto a Java framework implementation of the OSGi specification.

In some examples, SDN applications 331 can interact with the network devices 334 and/or virtual machines to incorporate new and/or additional functionalities into the SDN ecosystem 320. For instance, the SDN ecosystem 320 can include an SDN application store 325 that provides access to SDN applications 331 that can be installed on a network controller 333 to provide and/or modify functionality to a new and/or existing SDN. Further, the SDN application store 325 can be used to collect and maintain SDN applications 331 (e.g., in categories such as SDN, security 330, data center, virtual cloud 327, load balancing 328, UC&C 329, and infrastructure control 332, among others).

A user (e.g., human or machine) of the SDN application store 325 can login to a network controller 333 and install SDN applications 331 from the SDN application store 325 on the network controller 333. In some examples, the SDN application store 325 can be provided by a first entity that is distinct from an entity that owns and/or manages a particular SDN. For example, a supplier of SDN hardware (e.g., SDN network devices such as network controllers, switches, routers, etc.) and/or software can provide the SDN application store 325 for access by customers of the supplier. As such, the supplier, customers, and/or third parties can have access to the SDN application store 325. Access to the SDN application store 325 can include access to develop, use, simulate, certify, validate, purchase, and/or sell SDN applications 331, among other types of access. In some examples, users can collaborate to provide improvements to SDN applications 331. For example, users may provide recommendations and/or comments on how to improve various SDN applications 331. Additionally, users can browse and/or search for SDN applications 331 in the SDN application store 325.

SDN applications 331 in the SDN application store 325 can be shared with all users or with subsets of users. For example, a particular user can have a private portal to the SDN application store 325 that allows the particular user to have access to SDN applications 331 that are shared with the particular user, but not with all users. Similarly, the SDN application store 325 can promote wider exposure and/or increased sales for user developed SDN applications 331 by allowing a larger audience to access the SDN applications 331. In some examples, a provider of the SDN application store 325 (e.g., a provider of the front and back end infrastructure) may collect a portion of the sales recognized from the SDN application store 325.

In some examples, access to the SDN application store 325 can be provided via a graphical user interface (GUI). The GUI can include a display of SDN applications 331 organized by category. For example, the SDN applications 331 can be displayed in the SDN application store 325 and on a GUI, and can be organized into categories such as cloud, data center, featured, management, monitoring and troubleshooting, orchestration, and/or security, among other categories. From the GUI, a user can select a number of SDN applications 331 and install them on the user's network controller 333 via the GUI. Also, users can provide ratings for the SDN applications 331 in the SDN application store 325 via the GUI. A rating can include a numerical, alphanumerical, and/or symbolic value representing the user's satisfaction with a particular SDN application. In some examples, the GUI can provide descriptions of the SDN applications 331 to help users determine whether a particular SDN application is appropriate for the user's SDN.

The SDN ecosystem 320 can include an overlay network and an underlay network. As used herein, an overlay network refers to a network that is built on an underlay network. Also, as used herein, an underlay network refers to a number of SDN enabled network devices such as switches and/or routers. Network devices in the underlay network can employ an open protocol. One example of an open protocol for SDN is OpenFlow. As used herein, OpenFlow refers to which is a communications protocol that provides access to a forwarding plane of a network device over a network. Some examples of the present disclosure can operate according to OpenFlow. However, examples are not so limited, and examples of the present disclosure can operate according to other SDN protocols, and/or a hybrid of an SDN protocol combined with “normal” (e.g., distributed control plane) networking protocols. In some examples, network devices (e.g., routers) in the underlay network can be enabled with network functions virtualization (NFV) to provide some network functions with generic servers rather than dedicated network devices. For example, a virtual services router (VSR) can be deployed in a data center, branch, and/or cloud environment and can offer branch services that are centralized (e.g., in the data center), with branch instances logically managed as if they were remote but rather hosted in the data center. A VSR can be a single-tenant virtualized software wide area network (WAN) router designed for multi-tenant, hosted public clouds and virtualized branch customer-premises equipment (CPE) deployments. A VSR can be a virtualized software router that can run on VMware and/or a hypervisor (e.g., a software program that manages multiple operating systems, or multiple instances of the same operating system, on a single computer system). In some examples, network devices in the underlay network can be configured to support an overlay network (e.g., overlay enabled).

The overlay network can employ an encapsulation protocol such as virtual extensible local area network (VXLAN) to run the overlay network on the underlay network (e.g., on a Layer 2 and/or Layer 3 infrastructure). VXLAN can facilitate a cloud computing environment while logically isolating applications and/or tenants that use a portion of the cloud computing environment. For example, each tenant can have its own logical network and network identification in the cloud computing environment with an extended virtual local area network (VLAN) addressing space provided by VXLAN. The overlay network can employ network virtualization using generic routing encapsulation (NVGRE) to tunnel Layer 2 packets over a Layer 3 network to alleviate scalability problems associated with the cloud computing environment. In some examples, the overlay network can provide a number of virtual machines.

As illustrated in FIG. 3, the SDN ecosystem 320 can include an SDN SDK 326 (e.g., an open SDN SDK) to facilitate development, simulation, certification and/or validation of SDN applications 331. The SDN SDK 326 can be provided by executable instructions that can be downloaded and installed by a user and/or run remotely for use by the user. For example, the SDN SDK 326 can be provided as a virtual desktop infrastructure (VDI). A VDI can be a service that hosts user desktop environments on a remote server that can be accessed over a network using a remote display protocol. A connection brokering service can connect the user to a desktop session of the user so that the user can access the desktop of the user from any location without being constrained to a single device.

The SDN SDK 326 can include a development suite that includes APIs and documentation, a GUI framework, a VAN SDN controller 333, and a developer guide and/or sample code to help developers of SDN applications 331 with a development framework to quickly create SDN applications 331 directly on the VAN SDN controller 333. The SDN SDK 326 can include an API design model such as a representational state transfer (REST) API. REST can be an architectural style that abstracts architectural elements within a distributed hypermedia system that ignores the details of component implementation and protocol syntax in order to focus on the roles of components, the constraints upon interaction with other components, and interpretation of significant data elements. The SDN SDK 326 can include a RESTful API (e.g., a web API implemented using hypertext transfer protocol (HTTP) and REST principles as a collection of resources).

The SDN SDK 326 can include a simulation suite that allows users to download software directly into a development environment and simulate networks with network simulation modules (e.g., using modules that create a realistic virtual network, running real kernel, network device and application code, on a real or virtual machine to simulate how the SDN will respond to a particular SDN application before it is actually implemented live in the SDN). An example of a network simulation tool is Mininet. The SDN SDK 326 can include a certification and/or validation suite that can provide and/or perform a certification and/or validation test for SDN applications 331 to determine whether a particular application meets defined standards (e.g., set by a provider of the SDN ecosystem 320) so that SDN applications 331 can be given an indication of certification and/or validation for the comfort of users. Testing, certification and/or validation can provide investment protection to help ensure that a user's network infrastructure can support SDN applications 331 as they become available. In some examples, the SDN SDK 326 can include a community portal (e.g., a forum for users to share ideas) and/or a knowledge base to enable collaboration, including creation of private working groups, training, services, and support.

In some examples, the certification and/or validation suite can include an SDN virtual lab for testing SDN application functionality and interoperability across proprietary and/or open applications in a ready-made environment that simulates user conditions without requiring the user to have access to real network devices. The SDN virtual lab can be hosted in a cloud environment and can be accessible by a user (e.g., an application developer) to test an SDN application 331 with a set of shared network devices, such as switches, routers, and/or computing devices (e.g., a server) among other network devices. The virtual lab test can run on a set of real network devices and servers that are configured to be used in an isolated and protected configuration for the purpose of testing an SDN application 331. In some examples, once a particular virtual lab is reserved by a user, it can be exclusively used by the user for the duration of testing. The virtual lab can present a GUI to the user to allow the user to create a network to test the SDN application 331.

The SDN ecosystem 320 can include a number of modules to help users (e.g., information technology professionals, SDN application developers, etc.) to understand good practices for adopting and implementing an SDN. For example, the SDN ecosystem 320 can include a preparation module to help a user understand the user's network and how the SDN can be implemented. By way of example, the Open Flow protocol can be explained to the user and/or an introduction to the SDN SDK 326 can be provided. The SDN ecosystem 320 can include an engagement module that allows users to take SDN deployment courses and/or SDN development courses, among others. A user can have a service agreement with a provider of the SDN ecosystem 320 allowing the user to have access (e.g., via telephone, email, web interface, etc.) to explanations and clarifications of APIs, software documentation, sample SDN applications 331, troubleshooting resources for SDN applications 331 and/or network controller 333, development of workarounds, sharing best practices, knowledge, development expertise, and/or self-validation testing assistance, among others. Also, the SDN ecosystem 320 can include a delivery module that allows users and/or SDN applications 331 to earn certification and/or validation. In some examples, the delivery module can be used to deploy SDN applications 331 (e.g., to the SDN application store 325).

An example of an advantage of the SDN ecosystem 320 can be providing a user (e.g., a customer) with an ability to purchase, download, and/or install an SDN application 331 in one streamlined workflow. Developers and/or SDN application 331 users can have quick access to the SDN applications 331 to be dynamically deployed with very few inputs (e.g., clicks of a mouse and/or keyboard). By way of example, the user can use the SDN ecosystem 320 by downloading the network controller 333 (e.g., a VAN SDN controller) and/or the SDN SDK 326 and installing the same on a server. The user can login to the network controller 333 GUI to access the SDN application store 325 (e.g., a cloud-based store) using credentials identifying the user and/or access the SDN application store 325 from a browser outside the context of the network controller 333. Once the user selects an SDN application 331 to be downloaded, the user can select a number of network controllers 333 to which the SDN application 331 should be downloaded. The user can initiate and/or monitor the progress of the number of downloads (e.g., via the GUI). Once the number of downloads are complete, the SDN application 331 can be deployed on the number of network controllers 333. In some examples, the user can be provided with options to start and/or stop the SDN application 331 (e.g., via the GUI). Further, the SDN application store 325 can have the capability to push SDN applications 331 to selected network controllers 333 (e.g., using HTTP POST, which can be a request method supported by the HTTP for requesting a server to accept data enclosed in the request message body for storage). In some examples, the SDN application 331 can be compressed (e.g., in a zip format) and the network controller 333 can expose REST API to collect the SDN application 331 and unzip it to dynamically deploy an SDN application bundle.

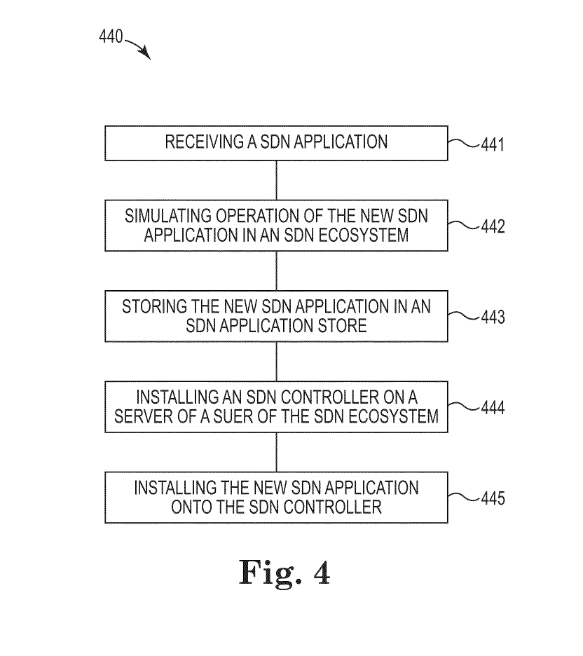

FIG. 4 is a flow chart illustrating a method 440 according to the present disclosure. At 441, the method 440 can include receiving a new SDN application from a first user of an SDN ecosystem. As used herein, a new SDN application refers to an SDN application not previously stored in the SDN application store in the SDN ecosystem. For instance, a new SDN application can include an SDN application that a user has developed, but that has not yet been approved by the provider of the SDN ecosystem. Similarly, a new SDN application can include an SDN application that a user is currently developing, but that is not yet completed (e.g., portions of the code for the SDN application have yet to be written and/or tested). In some examples, the user can develop the new SDN application with assistance from the SDN ecosystem. For instance, the SDN ecosystem (e.g., via the design implementation and support services module) can provide the user with sample code to assist in the development of the new SDN application.

At 442, the method 440 can include simulating operation of the new SDN application in the SDN ecosystem, in response to receiving the new SDN application from a user among a plurality of users of the SDN ecosystem. For example, a user of the SDN ecosystem can develop a new SDN application and wish to provide other users access to the new SDN application via the SDN application store. Prior to providing access to the new SDN application, the user (e.g., developer) can deploy (e.g., execute) the new SDN application in a test environment within the SDN ecosystem. During the simulation, the user can test the new SDN application functionality and interoperability with other SDN applications. Similarly, the user can test the new SDN application to verify that it functions properly with a variety of network devices.

At 443, the method 440 can include storing the new SDN application in the SDN application store in the SDN ecosystem in response to receiving approval of the simulated operation from a provider of the SDN ecosystem. For example, as described in relation to FIG. 3, a report and/or log can be generated from the simulated operation of the new SDN application. The report and/or log generated can be provided to the provider of the SDN ecosystem for review. The provider of the SDN ecosystem can review the report and/or log and reject or accept the new SDN application. In response to receiving approval (e.g., acceptance) of the new SDN application, the new SDN application can be stored in the SDN application store.

In response to storing the new SDN application in the SDN application store, other users may access the new SDN application. However, in some examples, access to the new SDN application can be provided to only a subset of the plurality of users of the SDN ecosystem. For example, only users meeting specified security requirements could access the new SDN application. In another example, only users identified by the developer and/or SDN provider as belonging to a particular group and/or network could have access to the new SDN application. Examples described herein are not limiting, however, and access to the new SDN application can be limited to a subset of the plurality of users of the SDN ecosystem in any manner.

In some examples, the method 440 can include providing certification for SDN applications in the SDN application store that satisfy standards defined by the provider of the SDN ecosystem. For example, as discussed in relation to FIG. 3, the SDN SDK can facilitate development, simulation, certification and/or validation of SDN applications. Certification and/or validation can indicate to users of the SDN ecosystem that the certified and/or validated SDN applications are of a particular quality.

At 444, the method 440 can include installing an SDN controller on a server of a second user of the SDN ecosystem in response to receiving a request from the second user to access the SDN ecosystem. For example, a user can use the SDN ecosystem by downloading an SDN controller and SDN SDK and installing both on a server within his SDN. The user can then log into the SDN controller GUI in order to access the SDN application store using his credentials (e.g., identifying information provided to the user from the provider of the SDN ecosystem). In some examples, the user can access the SDN application store from a browser without having to log into the SDN controller GUI.

At 445, the method 440 can include installing the new SDN application onto the SDN controller on the server of the second user in response to the user selecting the new SDN application for installation. For instance, once SDN applications, including new SDN applications, are available for users to access in the SDN application store, the SDN applications can be downloaded by users of the SDN ecosystem. Once the user selects a particular SDN application to be downloaded, and the user selects his SDN controller(s) to which the application needs to be downloaded, the SDN ecosystem can install the selected SDN application(s) onto the SDN controller(s) in the users' SDN. The SDN ecosystem can monitor progress of the installation, and display such progress to the user, for instance, on a GUI. Once the download of the SDN application to the SDN controller(s) is complete, the SDN application will be deployed onto the controller(s), and the user can be provided with options to start and/or stop the downloaded SDN applications as desired.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system, comprising:
a simulation engine to enable a first user among a plurality of users to upload a new software defined network (SDN) application into a development environment within an SDN ecosystem and simulate operation of the new SDN application in a network environment; and
an SDN application store engine to provide access to a plurality of SDN applications to the plurality of users, wherein the plurality of SDN applications includes the new SDN application.

2. The system of claim 1, further comprising an interactive environment engine to enable modification of the plurality of SDN applications by the plurality of users.

3. The system of claim 1, including the simulation engine to provide a software development kit (SDK) to develop, simulate, and validate the new SDN application.

4. The system of claim 1, including the SDN application store engine to enable a second user among the plurality of users to purchase an SDN application among the plurality of SDN applications.

5. The system of claim 1, wherein the SDN ecosystem includes an overlay network and an underlay network, and wherein the underlay network employs an open protocol.

6. A non-transitory machine readable medium storing instructions executable by a processing resource to cause a computer to:
simulate, in a software defined network (SDN) ecosystem, operation of a new SDN application, in response to receiving the new SDN application from a user of the SDN ecosystem;
provide, to a provider of the SDN ecosystem, results from the simulated operation of the new SDN application; and
provide, to a plurality of users of the SDN ecosystem, access to the new SDN application in response to the provider of the SDN ecosystem approving the new SDN application.

7. The non-transitory machine readable medium of claim 6, including instructions to provide the plurality of users access to a plurality of SDN applications, including the new SDN application, using an SDN application store.

8. The non-transitory machine readable medium of claim 6, including instructions to install a purchased SDN application on an SDN controller of a user among the plurality of users, in response to the user selecting the purchased SDN application from the SDN application store.

9. The non-transitory machine readable medium of claim 8, including instructions to install the purchased SDN application on the SDN controller of the user, using a virtual application networks (VAN) SDN controller in the SDN ecosystem.

10. The non-transitory machine readable medium of claim 9, including instructions to use the VAN SDN controller as an open services gateway initiative bundle.

11. A method, comprising:
receiving a new software defined network (SDN) application from a first user of an SDN ecosystem, wherein the new SDN application is not previously stored in an SDN application store in the SDN ecosystem;
simulating operation of the new SDN application in the SDN ecosystem in response to receiving the new SDN application;
storing the new SDN application in the SDN application store in the SDN ecosystem in response to receiving approval of the simulated operation from a provider of the SDN ecosystem;
installing an SDN controller on a server of a second user of the SDN ecosystem in response to receiving a request from the second user to access the SDN ecosystem; and
installing the new SDN application onto the SDN controller on the server of the second user in response to the user selecting the new SDN application for installation.

12. The method of claim 11, further including providing the second user access to the SDN application store in response to the second user providing user authentication.

13. The method of claim 11, wherein simulating operation of the new SDN application in the SDN ecosystem includes using a SDN software development kit provided as a virtual desktop infrastructure to simulate operation of the new SDN application.

14. The method of claim 11, further including providing the first user with a development guide to assist in development of the new SDN application.

15. The method of claim 11, further including providing certification for SDN applications in the SDN application store that satisfy standards defined by the provider of the SDN ecosystem.
